(19) United States
(12) Patent Application Publication
(10) Pub. No.: US 2003/0018492 A1
(43) Pub. Date: Jan. 23, 2003

(54) Method and apparatus for building project planning and budgeting

(76) Inventor: Ronald M. Carlson, Palatine, IL (US)

Correspondence Address: McAndrews, Held & Malloy, Ltd., 34th Floor, 500 West Madison Street, Chicago, IL, 60661, US

(21) Appl. No.: 10/199,207

(22) Filed: Jul. 19, 2002

Related U.S. Application Data
(60) Provisional application No. 60/307,022, filed on Jul. 20, 2001.

(51) Int. Cl. G06F 17/60

(52) U.S. Cl. 705/1

(57) ABSTRACT

Certain embodiments of the present invention provide a system and method for building project planning. The system includes an autoprogram module for producing a real estate project program based on at least one of user input and predetermined design parameters and an autobudget module for generating a project budget based on at least one of the real estate project program, the user input, and the predetermined design parameters. The method includes obtaining user input regarding a building project, producing a project program to aid in execution of the building project based on the user input, and generating a project budget based on the project program.

### RELATED APPLICATIONS

Provisional Application 60/307,022 filed Jun. 20, 2001

### STATEMENT REGARDING FEDERALLY SPONSORED RESEARCH OR DEVELOPMENT

Not Applicable

### BACKGROUND OF THE INVENTION

The present invention generally relates to automated planning for real estate or other building projects. More specifically, the present invention relates to space and resource planning for a building project, such as an architectural or construction project. The present invention also relates to budgeting for a building project.

A building project, such as new construction or remodeling, involves much planning and design prior to commencement of the project. Planning for a building project also involves coordination of many factors and many parties. Additionally, a project budget is desirable before designing and building has begun. During project planning, interaction and approval by multiple parties is currently required.

For traditional building or design projects, an architect, contractor, or other consultant generates a “program report” that outlines requirements for a target building area, a number of people to be at the target area (i.e., a head count), adjacent facilities and/or departments, work area standards, and other data necessary in defining a project's requirements. An architect creates a program report through interaction with an owner of the target area or building, for example. Then, an architect or designer generates a “space plan” based on the program report. The space plan is a two-dimensional drawing in scale plan form. Generation of a space plan by an architect or designer is needed in order to add project “takeoffs”, or construction components and/or details regarding length, area, volume, cost, and/or quantity of components or sub-components. Next, a “scope plan” is created by the architect or designer by taking the space plan and adding details, notes, specifications, or other information which further define the complexity and quality of the space plan pursuant to project requirements. The scope plan is a two-dimensional drawing in scale plan form accompanied by a narrative attachment of specifications and supplemental detail drawings. Finally, a “project budget” is prepared by a general contractor or other consultant after review and analysis of the scope plan data and drawings. The project budget is a report containing narrative and numerical data regarding the project and costs.

The traditional method of project planning and budgeting involves an architect, a contractor, an owner, and possibly users, tenants, or clients of the owner. Currently, all four steps described above must be executed to produce a useful project plan and budget. Current methods involve many different parties and a greater chance for inaccuracy or lack of organization. Thus, a need exists for an accurate and organized method for project planning and budgeting. Additionally, current project planning and budgeting methods involve several substantive steps to achieve a desired result. There is a need for an efficient method and system that minimizes the number of steps used to produce a project plan and budget. Furthermore, current methods of project planning and budgeting are time consuming, typically taking two weeks or more, because multiple parties are involved in the planning process and substantial plans and sketches are required first. Therefore, a need exists for a centralized, timely method and system for project planning and budgeting.

### BRIEF SUMMARY OF THE INVENTION

Certain embodiments of the present invention provide a system and method for real estate project planning. The system includes an autoprogram module for producing a real estate project program based on at least one of user input and predetermined design parameters and an autobudget module for generating a project budget based on at least one of the real estate project program, the user input, and the predetermined design parameters. The system may also include a user interface for accepting at least one of the user input and the predetermined design parameters. In certain embodiments, the user interface may be a Web-based query interface or computer software. The system may also include an output for outputting at least one of the real estate project program and the project budget. The output may be a display, a facsimile, a printer, a memory, and/or electronic mail.

The method includes obtaining user input regarding a building project, producing a project program to aid in execution of the building project based on the user input, and generating a project budget based on the project program. In certain embodiments, the building project may include remodeling and/or new construction, for example. The method may further include inputting project parameters from a user via a Web-based query interface. The project program may be produced based on the user input and preset program data. The project budget may be generated based on the project program and at least one of the user input and the preset program data. The method may also include outputting at least one of the project program and the project budget to at least one of a memory, a display, a printer, a facsimile, and electronic mail. The project program may include a detailed project program report, a project program summary, an itemized list of requirements, and/or at least one drawing. The project budget may include a detailed project budget report, a project budget summary, a project budget by category, and/or an itemized list of project requirements with costs.

### BRIEF DESCRIPTION OF SEVERAL VIEWS OF THE DRAWINGS

FIG. 1 illustrates a project planning system in accordance with an embodiment of the present invention.

FIG. 2 illustrates a flow diagram for a method for generating a project program in accordance with an embodiment of the present invention.

FIG. 3 illustrates a flow diagram for a method for generating a project budget in accordance with an embodiment of the present invention.

FIG. 4 illustrates an example of a project information input screen in accordance with an embodiment of the present invention.

FIG. 5 illustrates an example of an office/workstation input interface in accordance with an embodiment of the present invention.

FIG. 6 shows a sample program summary report in accordance with an embodiment of the present invention.

FIG. 7 illustrates a project budget information interface in accordance with an embodiment of the present invention.

FIG. 8 illustrates a project budget edit screen in accordance with an embodiment of the present invention.

FIG. 9 shows a capital budget report in accordance with an embodiment of the present invention.

The foregoing summary, as well as the following detailed description of certain embodiments of the present invention, will be better understood when read in conjunction with the appended drawings. For the purpose of illustrating the invention, there are shown in the drawings, certain embodiments. It should be understood, however, that the present invention is not limited to the arrangements and instrumentality shown in the attached drawings.

### DETAILED DESCRIPTION OF THE INVENTION

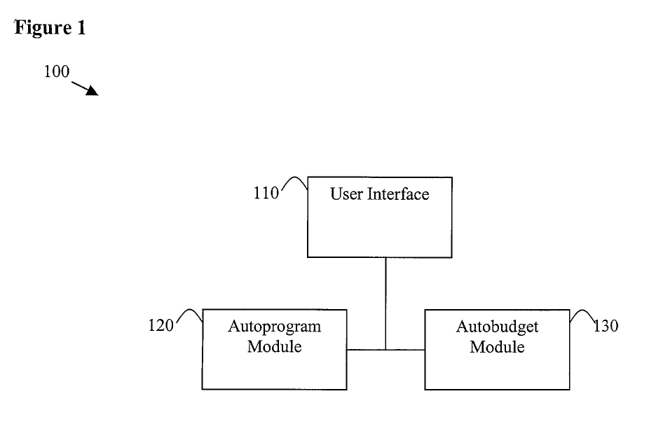

FIG. 1 illustrates a project planning system 100 in accordance with an embodiment of the present invention. The system 100 includes a user interface 110, an autoprogram module 120, and an autobudget module 130. The user interface 110, autoprogram module 120, and autobudget module 130 may be implemented in software and/or in hardware. The user interface 110, autoprogram module 120, and autobudget module 130 may be individual components or may be combined. The user interface 110, autoprogram module 120, and autobudget module 130 may be connected by wires, cables, Ethernet, local area network (LAN), wide area network (WAN), infrared connection, wireless connection, or other connection, for example.

The user interface module 110 obtains user input for project program and budget preparation by the autoprogram module 120 and the autobudget module 130. The user interface module 110 accepts user input and transmits the user input to the autoprogram module 120 and/or the autobudget module 130. In certain embodiments, the user interface 110 is a web interface accessible to users online. In another embodiment, the user interface 110 is standalone software installed on a personal computer.

The autoprogram module 120 accepts input from the user interface 110. The autoprogram module 120 generates a project program based on the input. The autoprogram module 120 may also use other project parameters, such as preset or stored information, to generate the project program.

In certain embodiments, the project program is a report. The project program report may be printed, displayed, transmitted by facsimile, and/or transmitted by electronic mail, for example. The project program may be a facility space programming report, a space planning area report, a scale plan, a scope plan, or other project report, for example. The project program may include area needs, facility head counts, adjacent departments and/or facilities, work area standards, and other narrative or numerical data. The project program may also include drawings, specifications, measurements, costs, and other supplemental information, for example.

In certain embodiments, the autobudget module 130 receives program information from the autoprogram module 120. In an alternative embodiment, the autobudget module 130 also receives input from the user interface 110. The autobudget module 130 generates a project budget based on the project program, preset or stored information, and/or user input.

In certain embodiments, the project budget is a report. The project budget includes narrative and numerical data, such as project requirements and associated costs, for example. The project budget may be printed, displayed, transmitted by facsimile, and/or transmitted by electronic mail, for example.

In operation, a user, such as an architect, builder, contractor, owner, or real estate agent, for example, provides input regarding the building or real estate project at the user interface 110. For example, an architect inputs information, such as building and room dimensions and door locations, into a Web-based query platform accessible via the Internet using a personal computer with a Web browser. User input may include physical characteristics of the project, such as dimensions and number and location of rooms, number of occupants, project time frame, financial constraints, material and equipment criteria, and other building information. The above information may also be preset or stored in the system 100.

After user input has been obtained, the user interface module 110 transmits the user input to the autoprogram module 120. For example, the input is entered into a cgi-based form on the web, and the input is then routed to the autoprogram module 120 processing unit or software. Then, the autoprogram module 120 uses the input, along with preset or preprogrammed data and design rules, to generate a project program. For example, the autoprogram module 120 uses the user input, such as a number of rooms and a number of occupants, and determines room size, building size, and layout based on preset rules, such as a rule governing a number of people allowed in a room of a given size. The autoprogram module 120 may then generate drawings and/or figures based on the project program. The autoprogram module 120 may also include facility specifications and supplemental notes to assist in construction.

Next, the project program is transmitted to the autobudget module 130. For example, the autoprogram module 120 may route the project program to the autobudget module 130 via Ethernet cable or wire. Alternatively, the autoprogram module 120 and the autobudget module 130 may be embodied in one unit. In certain embodiments, the autobudget module 130 uses the information contained in the project program to determine a budget for the building project. The project budget may be an overall budget and/or an itemized budget providing cost per room, per requirement, or per item, for example. For example, the autobudget module 130 may generate a project budget providing an architect and a contractor with a total cost for the building project, as well as itemized costs for materials.

The project program and/or the project budget may be output. For example, the project program and project budget may be transmitted to an architect or other builder via facsimile or electronic mail. The project program and/or the project budget may also be printed or displayed on a monitor, for example. The project program and/or project budget may be used by a site owner, an architect, a contractor, a builder, or other person to obtain and allocate materials, resources, and permits for a project, for example. The system 100 reduces interaction between parties. The system 100 also reduces manual steps and calculations undertaken to produce a project program and/or project budget.

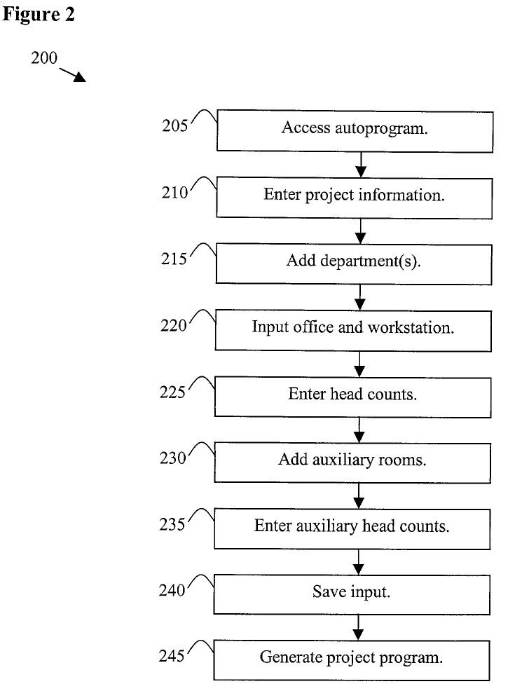

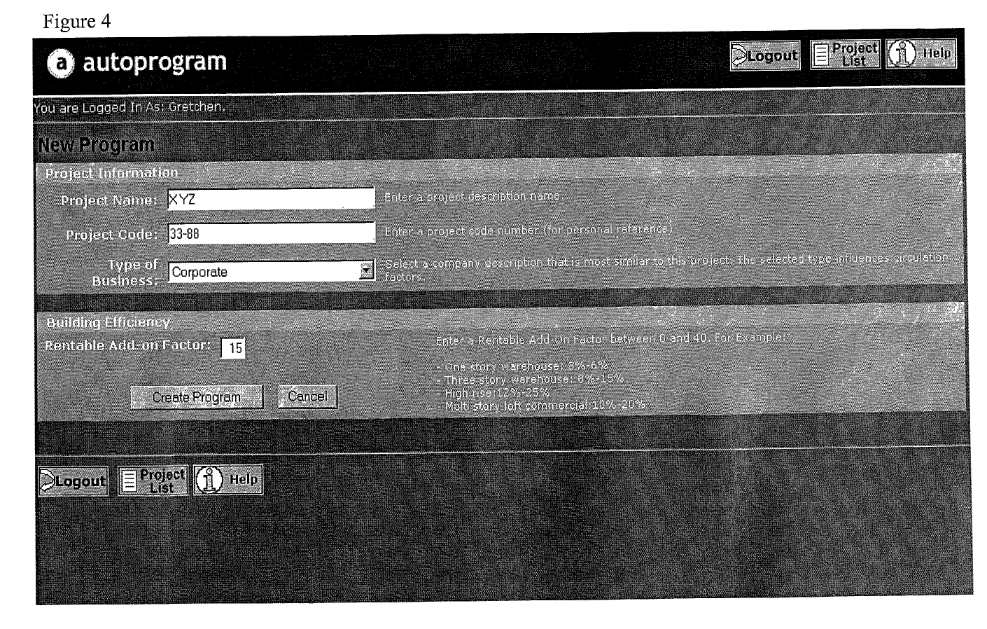

FIG. 2 illustrates a flow diagram 200 for a method for generating a project program in accordance with an embodiment of the present invention. First, at step 205, a user, such as an architect, builder, contractor, owner, or other party, accesses an autoprogram utility. For example, an architect inputs a logon name and password into a Web-based query interface. Then, at step 210, the user enters project information, such as a project name, a project reference code, and/or a type of business. The user may also enter a rentable add-on factor indicating the building's area “mark-up” for common areas (i.e., toilet rooms, public corridors, electrical closets, janitor closets, and other areas common to users of the site). In certain embodiments, the user enters a rentable add-on factor between 0% and 40%, with a one story warehouse having a factor of 3%-6%, a three story warehouse having 8%-15%, a high rise building having 12%-25%, and a multi-story commercial loft having a factor of 10%-20%. FIG. 4 illustrates an example of a project information input interface in accordance with an embodiment of the present invention.

Next, at step 215, department name(s) are added. In certain embodiments, at least one department is entered in order to assign personnel to departments during autoprogram. Departments may include accounting, administrative, customer service, executive, finance, human resources, legal, marketing, and public relations, as well as user-defined departments, for example. Departments may be added, deleted, renamed, and/or edited. For example, a user may input accounting and executive departments.

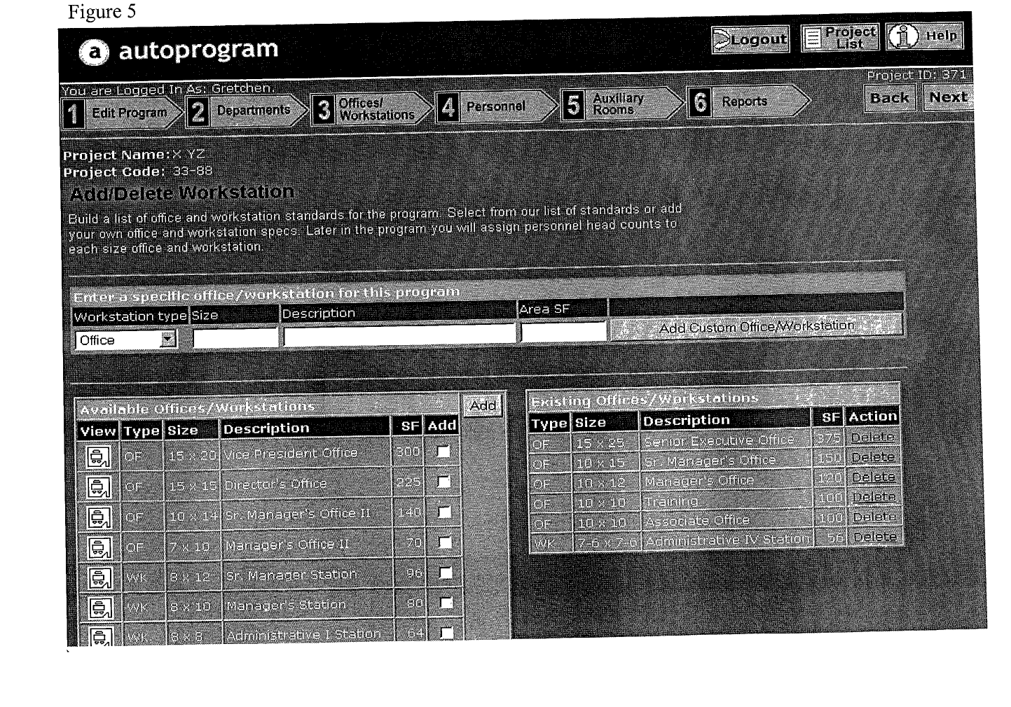

Then, at step 220, office and workstation standards may be input. Standards may be selected from a preset list or added by the user. In certain embodiments, dimensions and square feet are associated with office and workstation standards. For example, offices/workstations may include a senior executive's office (15 feet by 25 feet, 375 square feet), a vice president's office (15 feet by 20 feet, 300 square feet), a director's office (15 feet by 15 feet, 225 square feet), a senior manager's office (10 feet by 15 feet, 150 square feet), a second senior manager's office (10 feet by 14 feet, 140 square feet), a manager's office (10 feet by 12 feet, 120 square feet), an associate's office (10 feet by 10 feet, 100 square feet), a training office (10 feet by 10 feet, 100 square feet), a senior manager station (8 feet by 12 feet, 96 square feet), a manager's station (8 feet by 10 feet, 80 square feet), and an administration station (8 feet by 8 feet, 64 square feet). Offices and workstations may be added, deleted, renamed, and/or edited. For example, a user may add a senior executive office and a manager office to the executive department. FIG. 5 illustrates an example of an office/workstation input interface in accordance with an embodiment of the present invention.

Next, at step 225, head counts are entered for each department and/or each office or workstation within each department input by the user. In certain embodiments, head counts are divided into years or other time periods. For example, a user may input head counts for the current year and project an increase in head count for subsequent years. For example, a senior executive office may have a head count of 20 for the current year and a head count of 25 for the next year.

At step 230, auxiliary rooms may be added to the project. In certain embodiments, rooms have a type, a size, and a number of square feet. Rooms may be added, deleted, renamed, and/or edited by the user. For example, the user may select from among a computer/telephone room, a conference room, a copy/mail center, a pantry, a printer station, a reception area, a storage room, a boardroom, a kitchen, and/or a teaming area. Sizes of such rooms may include a small server room (100 square feet), an 8 person room (225 square feet), a small copy/mail room (150 square feet), a small service pantry (100 square feet), a typical printer location (36 square feet), a 2 guest seating area (150 square feet), a small room (120 square feet), a medium room (150 square feet), a typical room (120 square feet), a typical photocopier area (50 square feet), and a typical server/telephone room (150 square feet).

Then, at step 235, personnel head counts are entered for the rooms selected in step 230. As described above in relation to offices and workstations, head counts may be entered for the current year and subsequent years. For example, a designer may select one person for a 10-person boardroom for the current year and two people for the boardroom for the following year.

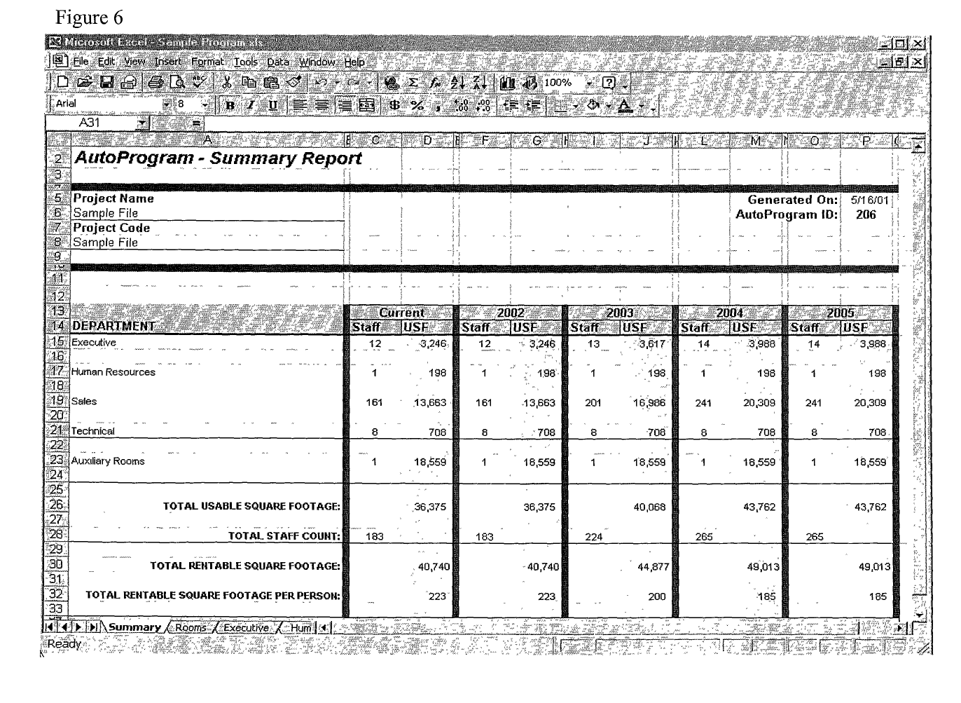

Next, at step 240, input from the user may be saved or stored. The saved input is used to generate a project program report. In step 245, the project program is generated. The project program may include a comprehensive program report, a summary report, and/or sub-reports, such as an auxiliary room report or department report, for example. The project program may include the departments, offices, workstations, and auxiliary rooms, along with a number of staff and usable square feet for each unit. The project program may also contain a total usable square footage, a total staff or head count, a total rentable square footage, and/or an amount of rentable square footage per person, for example. Additionally, the project program may include schematics or drawings of department, office, workstation, and/or auxiliary room layout and dimensions. The project program may be transmitted via electronic mail or facsimile, printed, stored in memory, displayed, and/or converted into a spreadsheet, such as a Microsoft Excel® spreadsheet, for example. FIG. 6 shows a sample program summary report in accordance with an embodiment of the present invention.

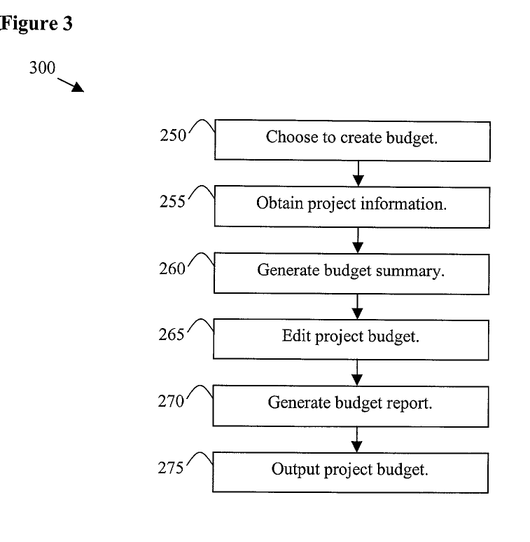

FIG. 3 illustrates a flow diagram 300 for a method for generating a project budget in accordance with an embodiment of the present invention. At step 250, the user may choose to create a project budget for the project program. The budget may be generated for the current year and/or subsequent years. For example, a builder may choose to generate a project budget for the current year and the next two years.

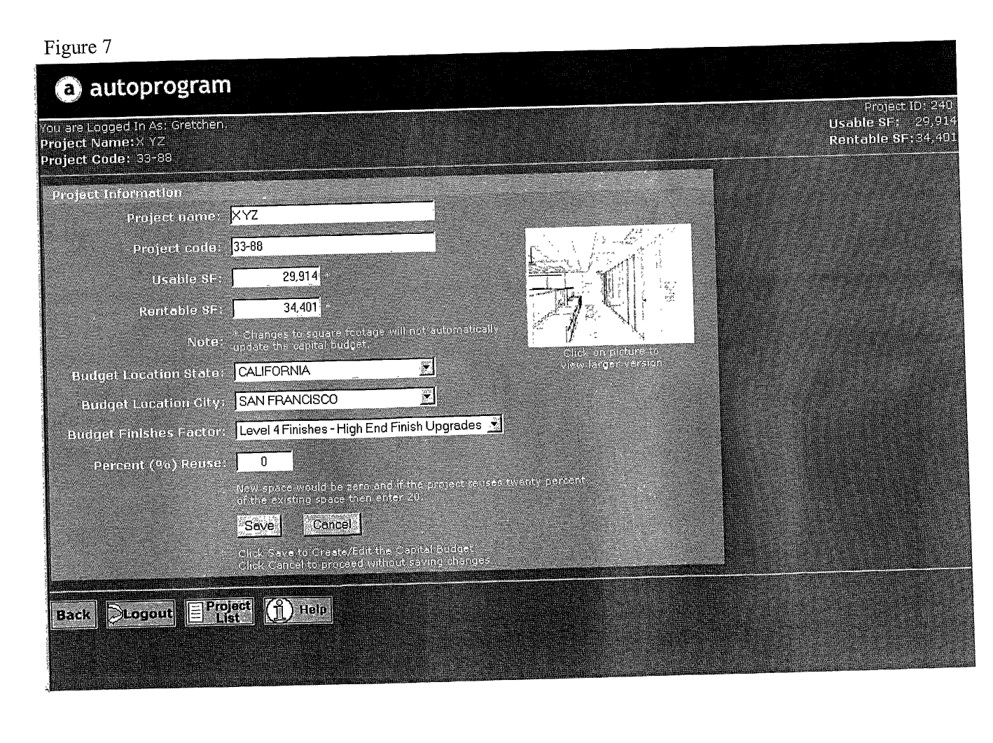

Then, at step 255, project information is obtained. The project information may be entered by a user, obtained from the project program, and/or retrieved from a preset or stored library of data, for example. Project information may include a project name, project code, a number of usable square feet in the project, a number of rentable square feet in the project, and project budget location (city and state, for example). Information may also include a budget finishes factor that indicates a level of finish upgrades to be added to the project. For example, level four finishes may represent high end finish upgrades, and level zero finishes may represent no finish upgrades. Images may be associated with the budget finishes factor to illustrate various finish upgrades. Additionally, a percent reuse factor may be used indicating if the project is to be completed on new space (0%) and/or by reusing existing space (a reuse of 20% of existing space, for example). For example, an architect may select to build a project in San Francisco, Calif., with level four high end finish upgrade and 0% reuse. The project information may be saved or simply used in budget determination and discarded. FIG. 7 illustrates a project budget information interface in accordance with an embodiment of the present invention.

At step 260, a project budget summary is generated based on the project information. The project budget may include a detailed project budget, a capital budget summary, a summary by category, and/or a summary by trade within a category. In certain embodiments, the capital budget summary includes a list of numbered categories, an amount per rentable square foot for each category, a budget amount for each category, a total amount per rentable square foot, and a total budget amount. Categories may include construction, furniture, equipment, consultant fees, relocation costs, appliances, miscellaneous, contingency, and concession allowances, for example.

A budget summary may be displayed by category. Under each category, sub-categories are listed by trade name, along with an amount per rentable square foot for each trade, a total budget amount for each trade, a total amount per rentable square foot for the category, and a total budget amount for the category, for example. For example, the furniture category may be divided into trades of freestanding furniture ($34.09/rentable square foot, $1,172,675.00 budget amount) and systems furniture ($0.93/rentable square foot, $31,900.00 budget). In certain embodiments, detailed budgets for each trade within a category may also be viewed.

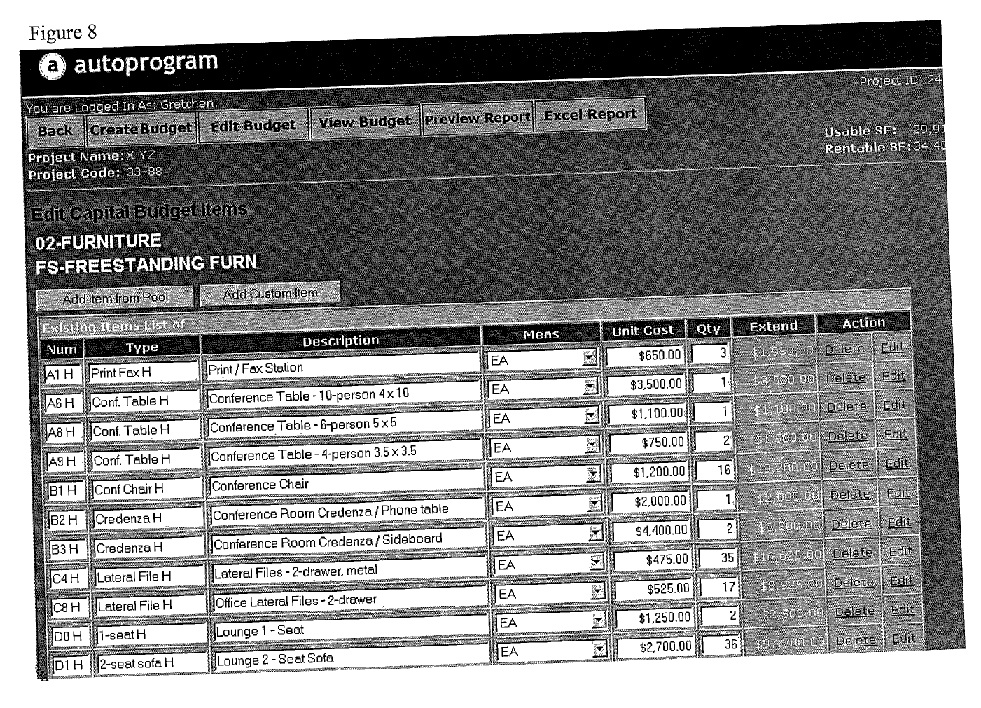

Then, at step 265, the project budget may be edited. Items from the existing project budget may be edited or deleted. New items may be added from a preset list. Additionally, custom items may be added by the user. Budget item number, type, description, measurement, unit cost, and quantity may be edited, for example. For example, an item such as a conference room credenza may be added to the freestanding furniture trade of the furniture category. A budget item indicating a print/fax station may be edited to change the quantity from one to three and the cost updated accordingly, for example. FIG. 8 illustrates a project budget edit screen in accordance with an embodiment of the present invention.

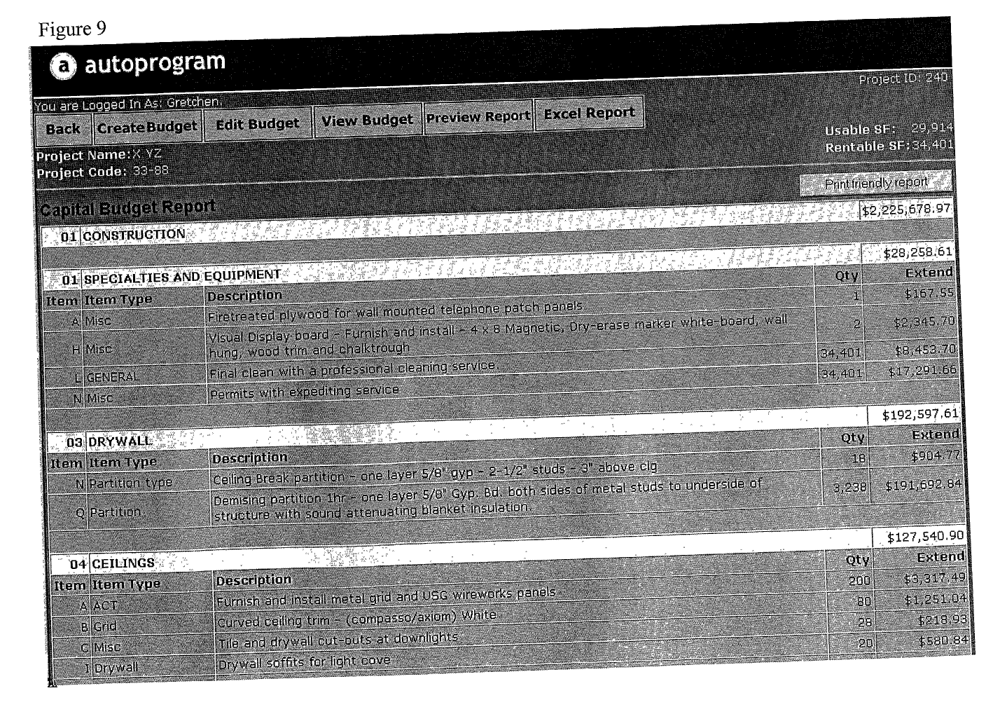

Next, at step 270, a project budget report is generated. The report may include additional items and information for the building project. In certain embodiments, the report is divided into categories, with items under each category. For each item, a description, a quantity, and a budget amount may be provided. For example, a ceiling category on a budget report may include items ACT, grid, miscellaneous, and drywall. The ACT item indicates furnish and install metal grid and USG wireworks panels, for example. The grid item indicates curved ceiling trim, for example. FIG. 9 shows a capital budget report in accordance with an embodiment of the present invention.

Finally, at step 275, the project budget may be output. The project budget may be printed, stored in memory, displayed, transmitted via electronic mail, and/or transmitted via facsimile, for example. The project budget may also be converted into a spreadsheet, such as a Microsoft Excel® spreadsheet. For example, an architect may transmit the project budget summary and report to a contractor via facsimile.

In certain embodiments, a user may be able to obtain accurate project data with reports in a fraction of the time allowed by current methods. Users may also have access to “real time” market cost indicators for various disciplines in many market sectors. In certain embodiments, vendors, contractors, dealers, manufacturers, and/or suppliers may be given exposure from the autobudgeting system. Additionally, project lead data may be provided in a form that protects project confidentiality.

Users may include architects, real estate brokers representing tenants, real estate brokers representing landlords or property managers, developers, and corporate facility managers, among others. For architects, for example, certain embodiments may reduce data entry and process time for program reports, as well as improve accuracy of reports. Architects may be able to create multidisciplinary budgets without first creating plans. Certain embodiments reduce process time for generating budgets. Certain embodiments allow creation of cost reports in any state or city based on present market conditions.

For tenant representative real estate brokers, certain embodiments allow creation of preliminary program and budget data without using an architect's services. Brokers may generate reports for a sales presentation. Program and budget data may enable a broker to create more accurate market analysis earlier than with current methods. Brokers may help sublease clients to abstract limitations of the client's product offering and concessions available. Brokers may use certain embodiments as an attachment to “request-for-proposals” for architects or other vendors and consultants. Additionally, brokers may offer certain embodiments of the present invention as a tool for a client to use directly.

In certain embodiments, developers and real estate brokers for landlords/property managers may close deals in an initial meeting rather than waiting several days to finalize a proposal to prospective tenants. Developers may be able to provide an accurate space allocation and tenant improvement scope package immediately. The detail report data may also be utilized for proposals and lease attachments.

Corporate facility managers may be able to create initial program and budget data without use of an architect's services. Corporate facility managers may be able to distribute program and budget data to a real estate brokers as market search criteria. Additionally, corporate facility managers may use project program and/or budget data as attachments to “request-for-proposals” for architects or other vendors and consultants.

Certain embodiments of the present invention minimize multiple party interactions involved in traditional building project planning and budgeting. Increased efficiency and centralization with the project planning system 100 may reduce a project planning and budgeting time frame from two to three weeks down to one hour, for example. Certain embodiments eliminate a need for preliminary project plans and specifications in order to achieve a detailed budget. Certain embodiments eliminate the traditional need for a space plan prior to budgeting and further planning.

Certain embodiments eliminate the current need to do project takeoffs from the space plan by facilitating automatic takeoff generation from user input into the project planning system 100. For example, a user may simply input a request for ten 150-square-feet offices. The project planning system 100 generates a plan for 10 L-shaped pieces of drywall, 10 doors, 10 frames, 10 hardware sets, and 22 light fixtures, for example. That is, certain embodiments of the present invention include takeoffs associated with a given building project. Certain embodiments also include finishing levels associated with a given project. Additionally, certain embodiments generate takeoffs and finishing levels for plans and/or budgets according to expenses, cost of living, and/or other requirements of various cities and/or states.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for planning a building project, said method comprising:
obtaining user input regarding a building project;
producing a project program to aid in execution of said building project based on said user input; and
generating a project budget based on said project program.

2. The method of claim 1, wherein said building project comprises remodeling.

3. The method of claim 1, wherein said building project comprises new construction.

4. The method of claim 1, wherein said producing step produces said project program based on preset program data and said user input.

5. The method of claim 1, wherein said generating step generates a project budget based on said project program and at least one of said user input and said preset program data.

6. The method of claim 1, further comprising outputting at least one of said project program and said project budget to at least one of a memory, a display, a printer, a facsimile, and electronic mail.

7. A method for real estate project planning, said method comprising:
inputting project parameters for a real estate project; and
generating a project program based on said project parameters and at least one of predetermined program data and design rules.

8. The method of claim 7, wherein said inputting step further comprises inputting project parameters for a real estate project from a user via a Web-based query interface.

9. The method of claim 7, further comprising outputting said project program.

10. The method of claim 7, wherein said project program comprises at least one of a detailed project program report, a project program summary, an itemized list of requirements, and at least one drawing.

11. The method of claim 7, further comprising generating a project budget based on said project program.

12. The method of claim 11, further comprising outputting said project budget.

13. The method of claim 11, wherein said project budget comprises at least one of a detailed project budget report, a project budget summary, a project budget by category, and an itemized list of project requirements with costs.

14. A system for automated real estate project planning, said system comprising:
an autoprogram module for producing a real estate project program based on at least one of user input and predetermined design parameters; and
an autobudget module for generating a project budget based on at least one of said real estate project program, said user input, and said predetermined design parameters.

15. The system of claim 14, further comprising a user interface for accepting at least one of said user input and said predetermined design parameters.

16. The system of claim 15, wherein said user interface comprises a Web-based query interface.

17. The system of claim 15, wherein said user interface comprises computer software.

18. The system of claim 14, further comprising an output for outputting at least one of said real estate project program and said project budget.

19. The system of claim 18, wherein said output comprises at least one of a display, a facsimile, a printer, a memory, and electronic mail.

20. The system of claim 14, wherein said autoprogram module produces a plurality of real estate project programs.

21. The system of claim 14, wherein said autobudget module generates a plurality of project budgets.
